(19) United States
(12) Patent Application Publication
(10) Pub. No.: US 2011/0011656 A1
(43) Pub. Date: Jan. 20, 2011

(54) HYBRID VEHICLE SYSTEM WITH INDIRECT DRIVE

(76) Inventor: Peder Ulrik Poulsen, Stratford, CT (US)

Correspondence Address: ST. ONGE STEWARD JOHNSTON & REENS, LLC, 986 BEDFORD STREET, STAMFORD, CT, 06905-5619, US

(21) Appl. No.: 12/868,447

(22) Filed: Aug. 25, 2010

Related U.S. Application Data
(63) Continuation-in-part of application No. 11/875,557, filed on Oct. 19, 2007, now abandoned.
(60) Provisional application No. 60/919,038, filed on Mar. 20, 2007.

(51) Int. Cl. B60K 6/48; F16H 35/00; F16H 7/00

(52) U.S. Cl. 180/65.25; 74/640; 474/148; 903/909

(57) ABSTRACT

A plug-in hybrid vehicle drive system, including an internal combustion engine for driving one or more wheels of a vehicle, at least one on-wheel electrically powered motor, the motor coupled to a speed reduction mechanism, the speed reduction mechanism coupled to a vehicle wheel for driving at least one wheel of the vehicle, a battery located in the vehicle and connected to the at least one on-wheel motor for supplying power to the on-wheel motor, a battery charger including an AC/DC power converter, and an AC outlet connector in communication with the battery charger for receiving power from an external source.

### CROSS-REFERENCE TO RELATED APPLICATIONS

This application is a continuation-in-part of co-pending U.S. patent application Ser. No. 11/875,557, filed Oct. 19, 2007, which claims the benefit of, under 35 U.S.C. 119(e), U.S. Provisional Patent Application No. 60/919,038, filed Mar. 20, 2007, each of which are hereby incorporated herein by reference in their entirety.

### FIELD OF THE INVENTION

The present invention relates to hybrid drive vehicles generally and more particularly to plug-in hybrid vehicles.

### BACKGROUND OF THE INVENTION

Some hybrid drive vehicles, known as hybrid electric vehicles (“HEV”), incorporate an internal combustion engine as well as at least one electric motor and a bank of batteries. Contrary to all-electric vehicles, in these first generation hybrids the batteries are not charged from the utility grid but from a generator driven by the engine. The addition of the electric motor improves fuel economy by enabling the engine to run at its most economical speed at all times and to be shut down rather than idling when the car is stationary. In some hybrids both systems drive the wheels directly whereas in others, so called series hybrids, the engine drives only a generator, which powers the electric motor and/or charges the batteries. It is generally recognized that in a hybrid electric vehicle the rated electric power needs to be the same order of magnitude as the rated power of the combustion engine for best fuel economy.

Various hybrid vehicle drive systems are known and some have been implemented in production vehicles. For example, U.S. Pat. No. 6,864,652 to Kubo et al. (“the Kubo patent”) discloses a drive system for an automotive vehicle including an internal combustion engine for driving the front wheels and an ancillary electric motor for driving the rear wheels. The vehicle is operable in both a front-wheel drive mode and a four-wheel drive mode. However, prior art systems such as the one disclosed in the Kubo patent require substantial modification and/or remanufacture of the vehicle power train to be implemented.

U.S. Pat. No. 6,644,427 to Schulte (“the Schulte patent”) discloses a system for providing parallel power in a hybrid vehicle. The system includes a compact electric motor that is coupled to an input shaft of the vehicle's transmission. The Schulte patent describes the system as being adaptable for installation in a conventional vehicle to convert it to a parallel hybrid-electric vehicle. However, the process requires the machining of components to fit the particular vehicle and requires modifications to the primary drive system of the vehicle including its drive shaft and transmission. For example, the conversion process described in the Schulte patent requires removing the vehicle's transmission and driveshaft, replacing the transmission input shaft, and mounting a motor to the transmission that is machined to fit the particular transmission.

There have been some prior attempts to employ in-wheel motors in vehicles. For example, U.S. Patent Application Publication No. 2007/0107959 to Suzuki et al. and U.S. Pat. No. 5,721,473 to DeVries disclose in-wheel motors. However, each of these prior art in-wheel motors includes a cylindrical stator circumscribing the wheel. This design is disadvantageous because it substantially reduces the space available for brakes and suspension components, and requires an entirely new custom wheel. A similar in-wheel motor is also disclosed in U.S. Pat. No. 5,438,228 to Couture et al. Each of these prior art in-wheel motors reduce the space provided for the vehicle's brakes and suspension components, and are not also adaptable for use on a vehicle's existing wheel.

There have also been prior attempts to attach a direct drive motor to a wheel coupled with an electrical system that can induce a rotational force on the wheel. U.S. Pat. No. 7,658,251 to James (“the James patent”) discloses a direct drive traction vehicle motor system for a wheeled vehicle. The system includes an electric motor rotor attached to a vehicle wheel with an electric motor stator attached concentrically around the rotor. This system does not disclose or contemplate a motor coupled to a speed reduction mechanism. The drawbacks to a direct drive motor include, considerable addition to the unsprung mass of the vehicle wheel, which can cause un-desired changes in vehicle handling characteristics. Although simple in nature, a direct drive system becomes bulky and heavy in relation to their rated power and torque, because the rotational speed of the motor is limited by the rotational speed of the wheel.

It is therefore desired to provide a geared hybrid vehicle drive system (indirect drive) that overcomes the drawbacks of the prior art. It is further desired to provide a hybrid vehicle drive system readily adaptable for implementation in existing non-hybrid vehicles.

It is further desired to provide a hybrid vehicle indirect drive system including plug-in capability. In recent years a novel category of hybrids, so called plug-in hybrids (“PHEV”) have appeared, designed to be charged from the electric grid while stationary. Plug-in hybrids further improve economy and mileage because energy drawn from the grid is many times less expensive than the same amount of energy delivered by an internal combustion engine. Several major vehicle manufacturers are working towards commercializing plug-in hybrids however they are still several years away. Within the last two years, some PHEV has become available from aftermarket sources that generally comprise a conventional hybrid with added battery capacity and modified control systems and are able to operate in an all-electric mode for short durations. However, an improved hybrid vehicle system with plug-in capability is desired.

### SUMMARY OF THE INVENTION

The present invention is based on the fact that relatively little power is required to propel a light car at a steady rate in regular highway traffic. Many vehicles require only 10-15 horsepower or even less during maybe 80% of time on the road. In most cars the balance of available engine power is only required for acceleration and hill climbing.

Accordingly, it is a principal objective of the invention to provide a geared electric drive-assist system to be added to conventional vehicles. For example, a system according to the invention may comprise electric motors each coupled to a speed reduction mechanism such as a gearbox, belt drive or roller chain in a step down configuration. The electric motor(s) is/are designed to bolt onto the vehicle, and the speed reduction mechanism connects the electric motor to the wheel so that the electric motor can impart a rotational force on the wheel. The electric motor can mount off center of the wheel. In one example, the speed reduction mechanism allows the use of a motor that rotates 3 to 4 times faster than the wheel. An indirect drive system provides several advantages over a direct drive system. The motor used can be considerably smaller for a given output power. A smaller motor brings along cost savings as well as weight savings. The weight savings coupled with an off center mounting location of the motor adds considerably less to the un-sprung mass in relation to a direct drive system dependent on the mounting location relative to the wheel center and the system attachment point. For example, if the motor is centered between the system attachment point and the wheel center, only 50% of the weight can be considered un-sprung mass. This advantage allows the indirect drive system to be installed with less impact on the vehicle handling characteristics.

Attachment points for the system include the wheel flanges, bumper, wheel wells, vehicle frame and the rear axles. The system may require the replacement of original wheels or the system may be adapted to attach to wheels currently in use on the vehicle. The system can still utilize the original suspension, brakes and wheel bearings. An indirect drive system according to the invention also incorporates a bank of batteries and power management module located in the trunk or elsewhere in the vehicle. The system may also include plug in capabilities that include a battery charger and an AC plug which can charge the batteries using power from an external source.

It is a further objective of the invention to provide an indirect electric drive system, which is sufficiently simple to be retrofitted to an existing vehicle by an auto repair shop or by a moderately mechanically proficient owner. A further objective of the invention is to propose inexpensive factory modifications to vehicles originally designed with only a combustion engine (e.g., gasoline or diesel), in order to facilitate addition of a drive system according to the invention. The indirect electric drive-assist system may be added by the factory during production, at purchase as a dealer option or at a later date whenever the owner may decide to do so.

These and other objectives are achieved by providing a plug-in hybrid vehicle indirect drive system, comprising an internal combustion engine for driving one or more wheels of a vehicle. The system further includes at least one electrically powered motor and a speed reduction mechanism coupled to the electrically powered motor and one of the wheels of the vehicle. A battery is located in the vehicle and connected to the at least one electrically powered motor for supplying power to the electrically powered motor. The system further includes a battery charger, an AC/DC power converter, and an AC outlet connector in communication with the battery charger for receiving power from an external source.

The speed reduction mechanism may include a gearbox, roller chain, belt drive or another equivalent transmission that provides a step down.

The indirect drive system may be attached to the vehicle by a connection rod. The connection rod providing sufficient degrees of freedom to absorb the relative movement between the axle and the vehicle body. The connection rod may include a ball and socket joint on each end. The attachment point for the connection rod may be located on the vehicle frame, wheel well or fender.

The electrically powered motor used in the indirect drive system may be mounted off center of the vehicle wheel. A conduit may be mounted to the vehicle with a power cable extending from a battery module to the electrically powered motor via the conduit.

In some embodiments, the system includes an adapter plate connectable to the wheel of the vehicle using the lug nuts on the vehicle wheel. The adapter plate includes one or a plurality of drive holes for receiving drive pins. The drive pins extend from an integrated shaft in the speed reduction mechanism, and the drive pins couple to the adapter plate and allow the electrically powered motor to impart a rotational force on the vehicle wheel.

The system may also include a driver operable controller in communication with the battery for controlling the power supplied to the at least one electrically powered motors. The vehicle can be adapted to be drivable by either or both of the internal combustion engine and the indirect electric drive system. The vehicle may further be fueled by diesel fuel.

Other objects of the invention are achieved by providing an indirect drive system including at least one electrically powered motor, a housing, and a speed reduction mechanism within said housing and coupled to said electrically powered motor via a power input shaft. The system further includes a power output shaft connectable to a wheel of a vehicle and a connection rod having a first end attached to said housing and a second end attachable to the vehicle. The speed reduction mechanism comprises a first component, being one of a gear, a sprocket or a pulley, coupled to the power input shaft, and a second component, being one of a gear, a sprocket or a pulley, coupled to said power output shaft. The first component has a diameter less than a diameter of the second component.

In some embodiments, the first component is an input gear and the second component is an output gear, wherein the speed reduction mechanism may further include at least one intermediate gear between the input gear and the output gear. In other embodiments, the first component is a first pulley and the second component is a second pulley, wherein the speed reduction mechanism further includes a belt extending around the first and second pulleys. In still other embodiments, the first component is a first sprocket and the second component is a second sprocket, wherein the speed reduction mechanism further includes a chain extending around the first and second sprockets.

Further provided is a hybrid vehicle indirect drive system, including at least one electrically powered motor, a speed reduction mechanism coupled to the electrically powered motor and a wheel of a vehicle, the speed reduction mechanism including an output shaft having one or a plurality of drive pin holes, and a battery connected to the at least one electrically powered motor for supplying power to the electrically powered motor. The system further includes an adapter plate attachable to lug nuts on the wheel of the vehicle, the adapter plate including one or a plurality of drive pin holes. Drive pins are inserted into the drive pin holes on the output shaft and the drive pin holes in the adapter plate such that that the drive pins impart a rotational force on the vehicle wheel when power is supplied to the electrically powered motor.

Also provided is a hybrid vehicle indirect drive system including at least one electrically powered motor, a speed reduction mechanism coupled to the electrically powered motor and a wheel of a vehicle, the speed reduction mechanism including a housing, and a battery connected to the at least one electrically powered motor for supplying power to the electrically powered motor. A connection rod attaches the housing of the speed reduction mechanism to the vehicle via an attachment point on the vehicle, the connection rod providing sufficient degrees of freedom to absorb relative movement between the wheel and the vehicle.

In some embodiments, the connection rod includes ball and socket joints on each end, a first one of the ball and socket joints attaching to the attachment point on the vehicle, and a second one of the ball and socket joints attaching to the housing.

Other objects of the present invention are achieved by providing an indirect drive system for a vehicle including an electric motor mounted to the vehicle outboard of the vehicle wheel, the electric motor attached to a vehicle wheel via a speed reduction mechanism, the speed reduction mechanism providing a step down gear ratio that allows the electric motor to rotate faster than the vehicle wheel, further a power cable connected to the stator for receiving electric power to the motor.

Further provided is a hybrid vehicle system including an internal combustion engine for driving two or more wheels of a vehicle, at least one motor for driving at least one wheel of the vehicle, the motor including a speed reduction mechanism, wherein the geared output of the motor is mechanically attached to a vehicle wheel, at least one battery for supplying power to each of the at least one motor, a battery charger including an AC/DC power converter, and an AC outlet connector in communication with the battery charger for receiving power from an external source.

A typical candidate for addition of an indirect drive-assist system according to the present invention is a light, small to mid-size vehicle with an internal combustion engine driving either the front wheels or the rear wheels. The indirect drive-assist system is installed on one or two axles and connected to a battery bank via a power management system located in the trunk or elsewhere in the car. The drive-assist system is largely independent of the original drive system, and control components enable the driver to operate the vehicle in engine mode or electric drive mode individually or together at will. Normally the car is started and brought up to cruising speed in engine mode, and then the gas pedal is released or the shift set to neutral, while engaging the drive-assist system. The on-wheel motors may then propel the car along a highway at a steady rate at zero or minimal fuel consumption. The engine can be re-engaged at any time and used together with or independently of the drive-assist system, but the system is designed to power the car on its own about 60-80% of the road time dependent on conditions and driver habits. It may also be able to perform low torque regenerative braking in either mode.

Other objects, features and advantages according to the present invention will become apparent from the following detailed description of certain advantageous embodiments when read in conjunction with the accompanying drawings in which the same components are identified by the same reference numerals.

### BRIEF DESCRIPTION OF THE DRAWINGS

FIG. 1 is an exploded view of one embodiment of an indirect electric drive system.

FIG. 2 is a cross section of the system show in FIG. 1.

FIG. 3A shows another embodiment of the indirect electric drive system.

FIG. 3B shows another embodiment of the indirect electric drive system.

FIG. 4 shows a perspective view of indirect electric drive assist system according to the present invention installed on a vehicle wheel.

FIG. 5 is a schematic representation of the components of the indirect drive system according to the present invention.

FIG. 6 shows a rear portion of a vehicle outfitted with an indirect drive system according to an exemplary embodiment of the present invention.

### DETAILED DESCRIPTION OF THE INVENTION

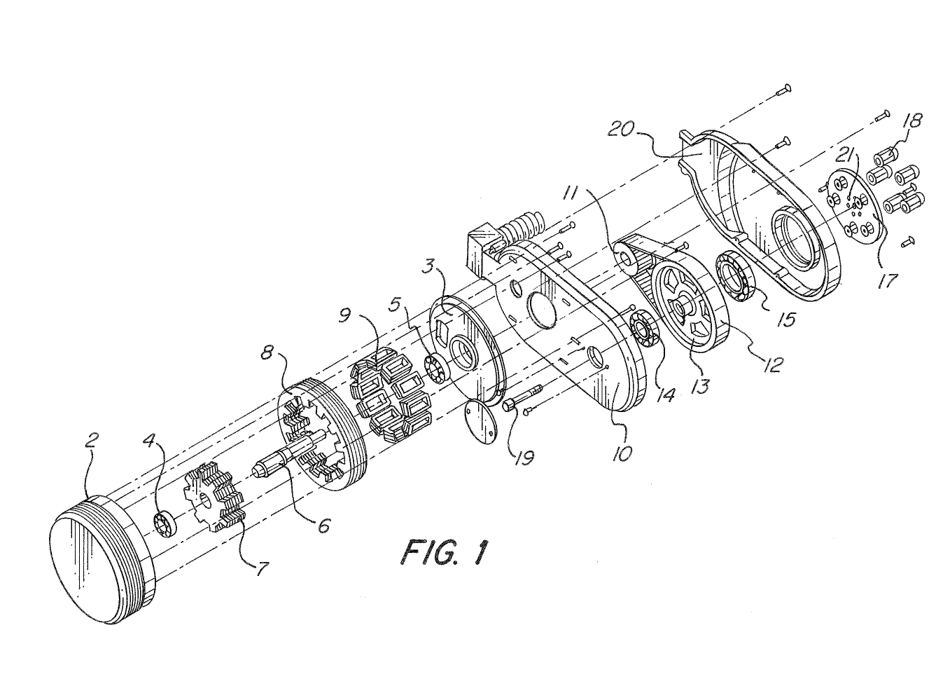

FIG. 1 is an exploded view of one embodiment of an indirect electric drive system according to one exemplary embodiment of the present invention. The exemplary embodiment is a belt driven design, however, as discussed in more detail below, the system may employ a number of other types of speed reduction mechanisms such as a V belt, roller chain, and sprockets or gears as well as other transmission elements all within the scope of the invention.

The system shown in FIG. 1 includes a motor 1, such as a Switched Reluctance DC motor, comprising a housing 2 and a cover 3. Other types of motors, such as an AC induction motor, a DC shunt motor, and a permanent magnet brushless DC motor may also be used. The housing 2 and cover 3 hold ball bearings 4 and 5, respectively. A motor shaft 6 is supported by the bearings 4 and 5.

A laminated rotor 7 is mounted to shaft 6. The motor 1 includes a stator 8 composed of stacked laminations with inwardly protruding poles, each pole being surrounded by a bobbin wound coil 9. In some embodiments, the stator 8 is comprised of high mechanical integrity plastic or resin. The stator 8 and rotor 7 are located concentrically inside the motor housing 2.

While a concentric arrangement of the rotor 7 and stator 8 is shown, the rotor 7 and stator 8 may also be positioned axially adjacent to one another. For example, the stator may include wound coils arranged (e.g., in a “flower petals” configuration) on a side surface of the stator. A rotor of heavy sheet steel with an array of magnets is placed in close proximity to the side surface of the stator. Other embodiments of the present invention may include two or more stators and/or two or more permanent magnet rotors arranged coaxially for increased torque.

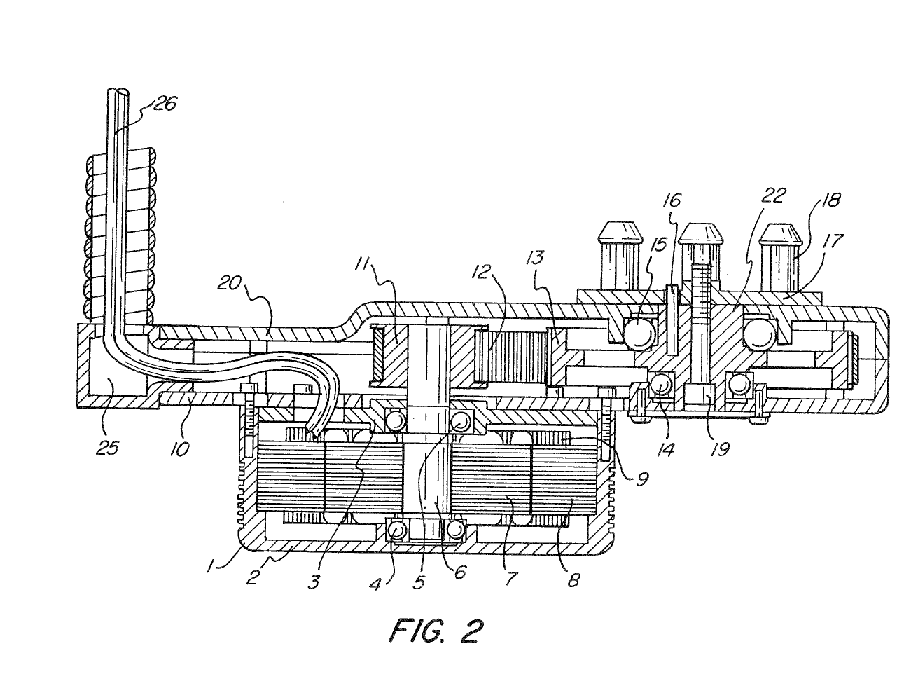

As shown in FIG. 1, the selected motor 1 is bolted onto a housing 10 and a timing belt pulley 11 is mounted onto the shaft 6 of the motor 1. A timing belt 12 connects pulley 11 and the driven timing belt pulley 13, which is supported between ball bearings 14 and 15. Bearing 14 is seated inside housing 10 and bearing 15 is seated inside hollow housing 20. An integral shaft 22 (See FIG. 2) of pulley 13 protrudes through the back plane of housing 20 and is drilled for drive pins 16 (See FIG. 2).

The pulley and belt configuration allows for a step down between the rpm of the shaft 6 and the wheel of the vehicle. For example, this exemplary embodiment may enable the use of a motor 1 which rotates for example 3 to 4 times faster than the wheel of the vehicle. In an alternative embodiment, the element 12 is a roller chain extending around two pulleys (e.g., 11 and 13) or sprockets and achieves similar performance.

The assembly connects to lug nuts 18 of vehicle's wheel by means of an adapter plate 17. The lug nuts 18 connect the vehicle wheel to the vehicle. A central bolt 19 extends through pulley 13 and connects with the adapter plate 17 via a central thread, and one or more drive pins 16 (See FIG. 2) engage a pattern of holes 21 in the adapter plate 17 securing a positive connection without slip.

FIG. 2 shows a cross section of the system shown in FIG. 1. In FIG. 2, the integral shaft 22 of pulley 13 can be seen protruding through hollow housing 20. One or more (e.g., three) drive pins 16 pass through the hole pattern 21 in adapter plate 17. The system further includes a conduit 25. Power is supplied to the motor 1 via a power cord 26 which passes into the vehicle through the conduit 25.

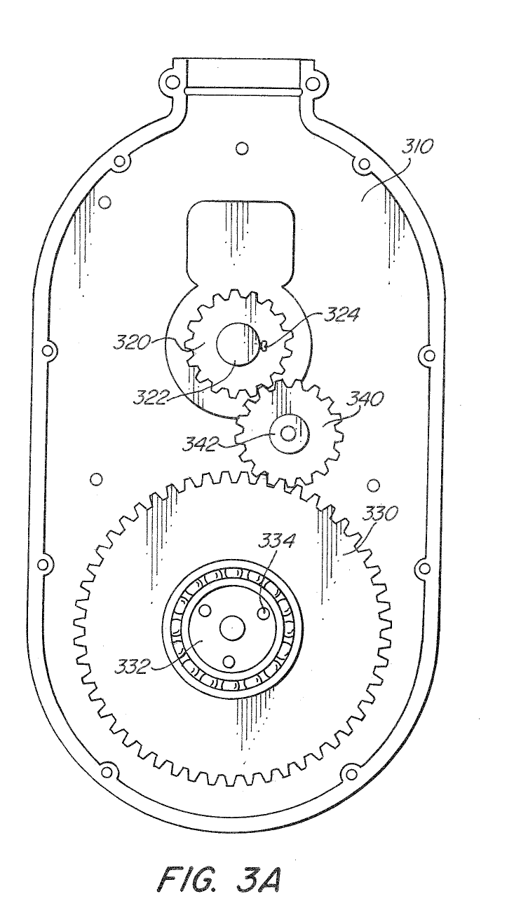

FIG. 3A shows an alternative speed reduction mechanism to the belt drive shown in FIGS. 1 and 2. This embodiment is a gear system having a 1:3 step down ratio and an intermediate gear to bridge the distance between input and output gears. This step down ratio advantageously allows the use of a lighter and more compact motor than a direct drive version. The speed reduction mechanism shown in FIG. 3A may produce approximately 1,000 rpm by means of a motor 1 running at 3,000 rpm.

As shown in FIG. 3A, the system includes a housing 310 including an input gear 320, and output gear 330, and an intermediate gear 340. An electric motor drive shaft 322 passes through a hole in housing 310. The shaft 322 is connected to and receives power input from the motor 1. The shaft 322 has a key 324, which inhibits rotation of the input gear 320 relative to the shaft 322. The input gear 320 meshes with the intermediate gear 340, which is rotatable about a shaft 342. The intermediate gear 340 meshes with the output gear 330. Output gear 330 has an integrated shaft 332 include drive pin holes 334. The shaft 332 is connectable to a wheel of a vehicle by means of an adapter plate 17 as shown in FIGS. 1 and 2. In particular, drive pins are inserted via the holes 334 to connect the shaft 332 to the adapter plate 17 as shown in FIGS. 1 and 2.

FIG. 3B shows another embodiment of the gear system having a two step reduction. In this embodiment, the input gear 320 is meshed with a first intermediate gear 340. The first intermediate gear 340 is mounted on the shaft 342 with a second intermediate gear 344 which meshes with the output gear 330. The first step down ratio between the gear 320 and gear 340 is 1:1.8. The second step down ratio between the gear 344 and the gear 330 is 1:3, giving a total step down ratio of 1:5.4. The speed reduction mechanism shown in FIG. 3A may produce approximately 1,000 rpm by means of a motor 1 running at 5,400 rpm.

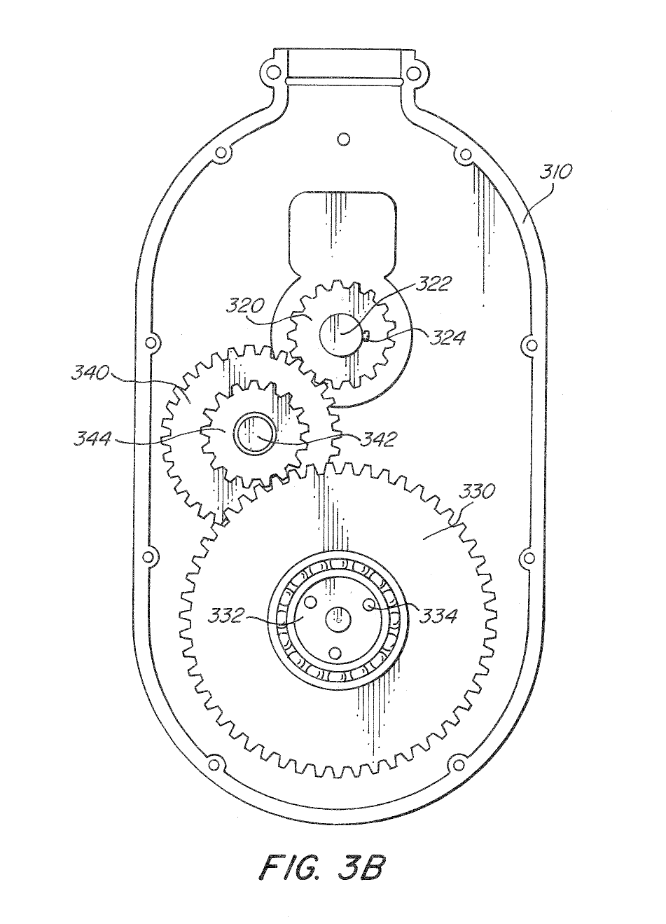

FIG. 4 shows a perspective view of indirect electric drive assist system according to the present invention installed on a vehicle 400. A connecting rod 410 is attached to the vehicle 400 on a mounting block or clamp 420, which is preferably located on the front rim of the fender 402 or other structurally rigid portion of the vehicle 400. The connecting rod 410 has ball and socket joints 422 and 424 on each end. The joints 422/424 absorb relative movement due to differences in loading and bumpy travel without any friction due to sliding motion. The connecting rod 410 is attached to the housing 10 and the mounting block 420 with bolts 432 and 434, respectively.

Power is supplied to the motor 1 through a conduit 25. The conduit 25 extends next to the wheel 440 of the vehicle 400 and into the wheel well for connection to a power system (e.g., located in the trunk of the vehicle 400). For example, the conduit 25 may extend through a rubber lined bushing attached to the body behind or above the wheel 440.

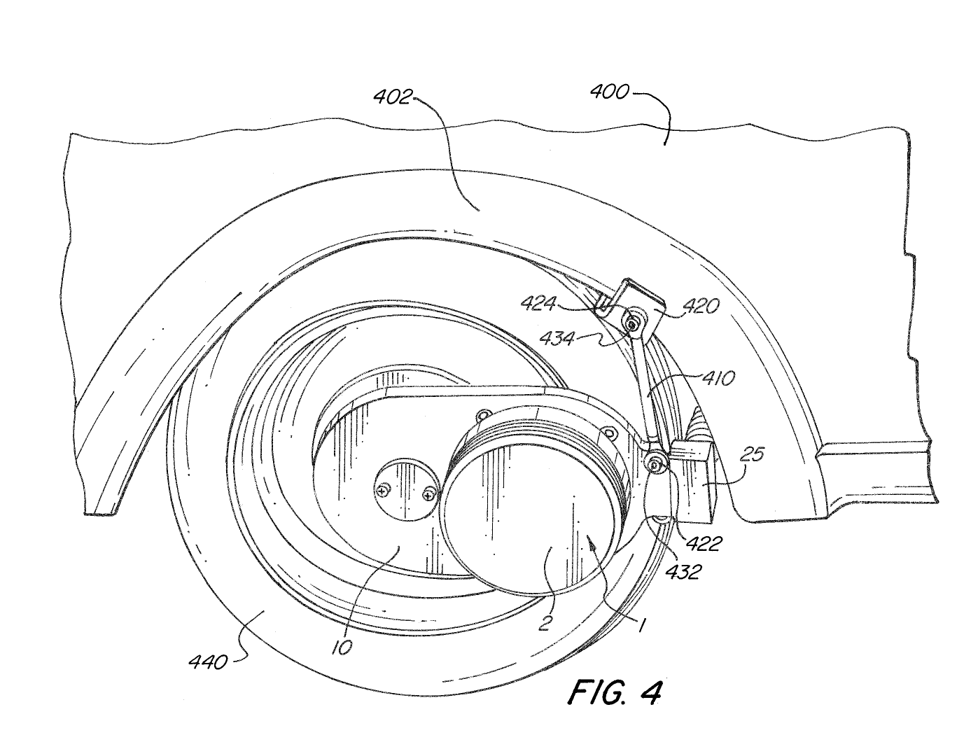

FIG. 5 shows a schematic of the indirect drive system according to the present invention. The cable 26 extends through the conduit 25 to a power management module 502 located in the trunk or elsewhere in the vehicle 400. The system further includes a battery module 504 connected to the power management module 502, a charger 506 (e.g., including a DC to AC power converter), and an AC outlet connector 508. The battery module 504 may include, for example, a plurality of lead acid batteries or preferably lithium-ion batteries.

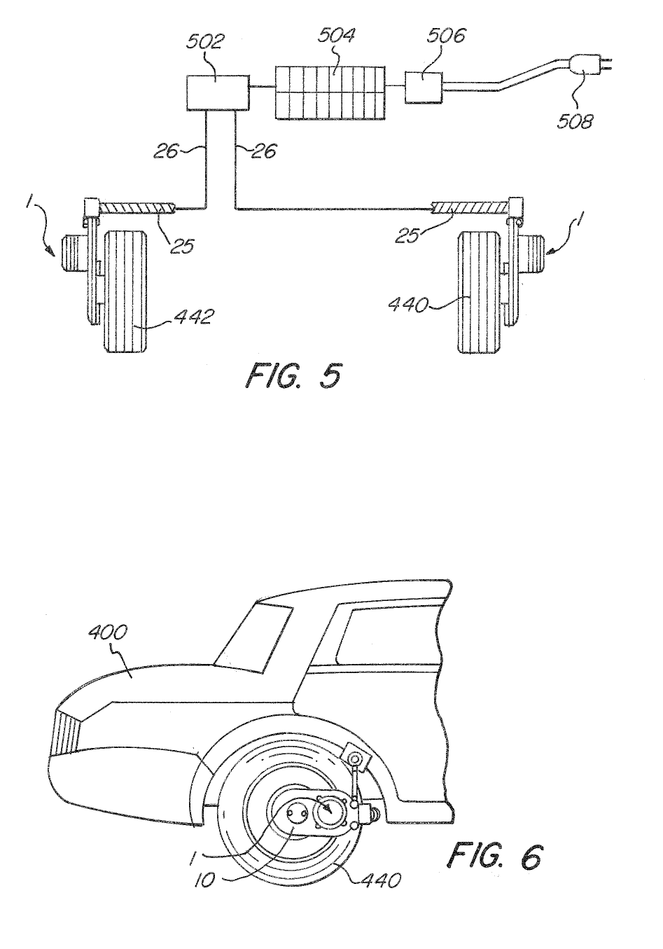

FIG. 6 shows the rear portion of a vehicle 400 outfitted with an indirect drive system according to an exemplary embodiment of the present invention. The housing 10 and motor 1 are mounted external to the wheel 440. The system may be implemented on one or both rear wheels of the vehicle 400, and/or on either or both of the front wheels (not shown). As shown in FIG. 6, the motor 1 is located horizontally off center between the wheel 440 and the vehicle frame. While the system is shown mounted in a horizontal configuration, it may also be mounted vertically (e.g., extending upwards) to accommodate different vehicle types. However, in the vertical configuration, the entire weight of the motor, transmission, and housing is added to the unsprung weight, whereas in the preferred horizontal configuration only about half of the weight of the motor can be considered unsprung weight.

As one of ordinary skill will understand from the preceding description, the present invention provides a novel system for supplementing power to a vehicle as an aftermarket or dealer installed add-on system, or as an original equipment option on the vehicle. The present invention may be implemented with minimal modification to the vehicle and minimal added weight. For example, some embodiments of the present invention employ the existing axles and wheels of the vehicle. By way of the present invention, any vehicle may be readily converted into a hybrid vehicle and preferably a plug-in hybrid vehicle.

The indirect drive system of the present invention advantageously allows for use of a smaller motor than in prior art systems due the speed reduction mechanism. Thus, the motor can be designed considerably smaller for a given output power bringing along savings in cost and total weight over the direct drive system. The motor may also be mounted off-center from the wheel. The motor adds less to the un-sprung mass dependent on its location between the wheel center and the system attachment point. For example, if the motor is centered between the two points only 50% of its weight can be considered un-sprung mass.

Although the invention has been described with reference to a particular arrangement of parts, features and the like, these are not intended to exhaust all possible arrangements or features, and indeed many modifications and variations will be ascertainable to those of skill in the art.

What is claimed is:

1. A plug-in hybrid vehicle indirect drive system, comprising:
an internal combustion engine for driving one or more wheels of a vehicle;
at least one electrically powered motor;
a speed reduction mechanism coupled to said electrically powered motor and one of the wheels of the vehicle;
a battery located in the vehicle and connected to said at least one electrically powered motor for supplying power to said electrically powered motor;
a battery charger including an AC/DC power converter; and
an AC outlet connector in communication with said battery charger for receiving power from an external source.

2. The system according to claim 1, wherein said speed reduction mechanism includes an input shaft connected to and driven by said electrically powered motor and an output shaft connected to and driving the wheel, wherein the output shaft rotates at a speed less than a speed of the input shaft when power is applied to said electrically powered motor.

3. The system according to claim 1, wherein said speed reduction mechanism comprises a gear system including an input gear coupled to the electrically powered motor and an output gear coupled the wheel.

4. The system according to claim 3, further comprising at least one intermediate gear between the input gear and the output gear.

5. The system according to claim 1, wherein said speed reduction mechanism comprises a belt drive system including a first pulley coupled to the electrically powered motor, a second pulley coupled the wheel, and a belt extending around the first and second pulleys.

6. The system according to claim 1, wherein said speed reduction mechanism comprises a roller chain system including a first sprocket coupled to the electrically powered motor, a second sprocket coupled the wheel, and a chain extending around the first and second sprockets.

7. The system according to claim 1, further comprising:
a housing comprising the speed reduction mechanism; and
a connection rod attaching the housing to the vehicle.

8. The system according to claim 7, wherein said connection rod connects to an attachment point on the vehicle, wherein the attachment point is located on one of a frame, wheel well, or fender of the vehicle.

9. The system according to claim 8, wherein said connection rod comprises ball and socket joints on each end, a first one of said ball and socket joints attaching to the attachment point on the vehicle, and a second one of said ball and socket joints attaching to said housing.

10. The system according to claim 1, wherein said motor includes a stator comprised of at least one of a plurality of wound coils and an iron core.

11. The system according to claim 1, wherein said electrically powered motor is located off center with respect to said wheel.

12. The system according to claim 1, further comprising:
a conduit; and
a power cable extending from said battery module to the electrically powered motor via said conduit.

13. The system according to claim 1, further comprising:
an adapter plate between the speed reduction mechanism and the wheel, said adapter plate attached to the wheel of the vehicle; and
a power output shaft coupled to said speed reduction mechanism and said adapter plate.

14. The system according to claim 1, further comprising:
a driver operable controller in communication with said battery for controlling the power supplied to the at least one electrically powered motors.

15. The system according to claim 1, wherein said internal combustion engine is fueled by a diesel fuel.

16. The system according to claim 1, comprising:
a second electrically powered motor;
a second speed reduction mechanism coupled to said second electrically powered motor and a second one of the wheels of the vehicle.

17. An indirect drive system, comprising:
at least one electrically powered motor;
a housing;
a speed reduction mechanism within said housing and coupled to said electrically powered motor via a power input shaft;
a power output shaft connectable to a wheel of a vehicle;
a connection rod having a first end attached to said housing and a second end attachable to the vehicle;
wherein said speed reduction mechanism comprises a first component, being one of a gear, a sprocket or a pulley, coupled to the power input shaft, and a second component, being one of a gear, a sprocket or a pulley, coupled to said power output shaft; and
wherein the first component has a diameter less than a diameter of the second component.

18. The system according to claim 17, wherein the first component is an input gear and said second component is an output gear.

19. The system according to claim 18, wherein said speed reduction mechanism further comprises at least one intermediate gear between the input gear and the output gear.

20. The system according to claim 17, wherein the first component is a first pulley and the second component is a second pulley, wherein said speed reduction mechanism further comprises a belt extending around the first and second pulleys.

21. The system according to claim 17, wherein the first component is a first sprocket and said second component is a second sprocket, wherein said speed reduction mechanism further comprises a chain extending around the first and second sprockets.

22. The system according to claim 17, wherein the power output shaft rotates at a speed less than a speed of the power input shaft when power is applied to said electrically powered motor.

23. A plug-in hybrid vehicle indirect drive system, comprising:
at least one electrically powered motor;
a speed reduction mechanism coupled to said electrically powered motor and a wheel of a vehicle, said speed reduction mechanism comprising an output shaft having at least one drive pin holes;
a battery connected to said at least one electrically powered motor for supplying power to said electrically powered motor;
an adapter plate attachable to lug nuts on the wheel of the vehicle, said adapter plate comprising at least one drive pin holes;
one or more drive pins, each drive pin inserted into one of the drive pin holes on said output shaft and one of the drive pin holes in said adapter plate; and
wherein said drive pins impart a rotational force on the vehicle wheel when power is supplied to said electrically powered motor.

24. A plug-in hybrid vehicle indirect drive system, comprising:
at least one electrically powered motor;
a speed reduction mechanism coupled to said electrically powered motor and a wheel of a vehicle, said speed reduction mechanism comprising a housing;
a battery connected to said at least one electrically powered motor for supplying power to said electrically powered motor;
a connection rod attaching the housing of said speed reduction mechanism to the vehicle via an attachment point on the vehicle, said connection rod having sufficient degrees of freedom to absorb relative movement between the wheel and the vehicle.

25. The system according to claim 24, wherein connection rod comprises ball and socket joints on each end, a first one of said ball and socket joints attaching to the attachment point on the vehicle, and a second one of said ball and socket joints attaching to the housing.
